(19) United States
(12) Patent Application Publication
(10) Pub. No.: US 2024/0265350 A1
(43) Pub. Date: Aug. 8, 2024

(54) DIGITAL CAREER COACH

(71) Applicant: ADP, Inc., Roseland, NJ (US)

(72) Inventors: Deepa Muralikrishnan, Roseland, NJ (US); Marc Rind, Parsippany, NJ (US); Rajesh Uttamchandani, Roseland, NJ (US); Amit Kumar Sharma, Hyderabad (IN); Manoj Oleti, Hyderabad (IN); Eric Zitaner, Parsippany, NJ (US); Samir Khanal, Los Angeles, CA (US); Michael Ratcliff, Parsippany, NJ (US); Anthony Heyliger, Parsippany, NJ (US); John Sheehy, Alpharetta, GA (US); Teresa Geiger, Parsippany, NJ (US); Elaine Clement, Los Angeles, CA (US); Jesse Zolna, New York, NY (US); Neha Pahwa, New York, NY (US); Saravanan Sundaresan, Marlborough, MA (US); DeAnna Carey, Troy, MI (US); James Mason, Roseland, NJ (US)

(73) Assignee: ADP, Inc., Roseland, NJ (US)

(21) Appl. No.: 18/506,787

(22) Filed: Nov. 10, 2023

Related U.S. Application Data
(63) Continuation of application No. 16/417,766, filed on May 21, 2019, now abandoned.

(51) Int. Cl. G06Q 10/1053; G06Q 10/0631; G06Q 50/20

(52) U.S. Cl. CPC G06Q 10/1053; G06Q 10/063112; G06Q 50/2057

(57) ABSTRACT

Career coaching comprising defining a number of employment positions, wherein each employment position comprises a number of required skills. Relationships between the employment positions are modeled, wherein the model maps potential transitions between employment positions according to similarities of required skills. A number of persons who have occupied the employment positions are modeled according to skills, employment history, and job performance. A user provides user data that comprises skills, employment history, and job performance. The user data is compared to the modeled persons, and a number of potential employment opportunities from among the number of employment positions are matched to the user based on similarities between the user and the modeled persons. The potential employment opportunities are then displayed to the user on a graphical user interface.

### BACKGROUND INFORMATION

### 1. Field

The present disclosure relates generally to an improved computer system and, in particular, to modeling potential career paths for users according to skill sets and similarities to persons who have occupied similar job positions.

### 2. Background

Recruiting and retaining qualified employees is a perennial issue facing organizations. Conversely, employees seek to navigate their careers within and outside their organizations. Curiously, research indicates that only a small percentage of employees leave a company for higher pay. The majority leave for opportunities to develop professionally.

Each employment position necessarily requires specific skill sets. Matching employees or prospective employees with jobs and career paths typically involves establishing specific credentials required for each job. However, an official credential is not always an accurate indicator of past or future work performance or an accurate indicator of required skill sets for employment positions. They are at best indirect proxies for such skills.

Employees seeking to advance their careers often do not know paths they can take. Their current employment positions and credentials do not necessarily point in specific directions, and the complexity of interrelations between different jobs can be overwhelming and incomprehensible without advanced data processing and modeling.

### SUMMARY

An illustrative embodiment provides a computer-implemented method comprising defining a number of employment positions, wherein each employment position comprises a number of required skills, and modeling relationships between the employment positions, wherein the model maps potential transitions between employment positions according to similarities of required skills. A number of persons who have occupied the employment positions are modeled according to skills, employment history, and job performance. User data comprising skills, employment history, and job performance is received from a user and compared to the modeled persons. A number of potential employment opportunities from among the number of employment positions are matched to the user based on similarities between the user and the modeled persons and displayed to the user on a graphical user interface.

Another illustrative embodiment provides a system for career coaching comprising a bus system; a storage device connected to the bus system, wherein the storage device stores program instructions; and a number of processors connected to the bus system, wherein the number of processors execute the program instructions to: define a number of employment positions, wherein each employment position comprises a number of required skills; model relationships between the employment positions, wherein the model maps potential transitions between employment positions according to similarities of required skills; model a number of persons who have occupied the employment positions according to skills, employment history, and job performance; receive user data from a user, wherein the user data comprises skills, employment history, and job performance; compare the user data to the modeled persons; match a number of potential employment opportunities from among the number of employment positions to the user based on similarities between the user and the modeled persons; and display the number of potential employment opportunities to the user on a graphical user interface.

Another illustrative embodiment provides a computer program product for career coaching comprising a non-volatile computer readable storage medium having program instructions embodied therewith, the program instructions executable by a number of processors to cause the computer to perform the steps of: defining a number of employment positions, wherein each employment position comprises a number of required skills; modeling relationships between the employment positions, wherein the model maps potential transitions between employment positions according to similarities of required skills; modeling a number of persons who have occupied the employment positions according to skills, employment history, and job performance; receiving user data from a user, wherein the user data comprises skills, employment history, and job performance; comparing the user data to the modeled persons; matching a number of potential employment opportunities from among the number of employment positions to the user based on similarities between the user and the modeled persons; and displaying the number of potential employment opportunities to the user on a graphical user interface.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an information environment in accordance with an illustrative embodiment;

FIG. 2 is a block diagram of a computer system for modeling in accordance with an illustrative embodiment;

FIG. 3 is a career graph depicting potential paths between different employment positions in accordance with illustrative embodiments;

FIG. 4 depicts a graph of potential transitions across various jobs in accordance with illustrative embodiments;

FIG. 5 is a diagram that illustrates a node in a neural network in which illustrative embodiments can be implemented;

FIG. 6 is a diagram illustrating a restricted Boltzmann machine in which illustrative embodiments can be implemented;

FIG. 7 depicts the process of building a career coaching system in accordance with illustrative embodiments;

FIG. 8 depicts a process flow for model training in accordance with illustrative embodiments;

FIG. 9 depicts a process flow for model development in accordance with illustrative embodiments;

FIG. 10 depicts a user interface start screen for a career coaching system in accordance with illustrative embodiments;

FIG. 11 depicts a user interface career path display for a career coaching system in accordance with illustrative embodiments;

FIG. 12 depicts a user interface job detail display for a career coaching system in accordance with illustrative embodiments;

FIG. 13 depicts a process flow for determining a projected career path in accordance with illustrative embodiments;

FIG. 14 depicts a process flow for identifying potential employees in accordance with illustrative embodiments; and

FIG. 15 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that organizations are constantly looking to recruit and retain qualified employees, and that employees continually seek to advance their careers within and outside their organizations.

The illustrative embodiments further recognize and take into account that an official credential is not always an accurate indicator of past or future work performance or an accurate indicator of required skill sets for employment positions.

The illustrative embodiments further recognize and take into account that employees seeking to advance their careers often do not know paths they can take, and that the complexity of interrelations between different jobs can be overwhelming and incomprehensible without advanced data processing and modeling.

Illustrative embodiments provide a method and system for employees to explore multiple career paths taken by similar people based on educational background, experience, skill sets, performance, etc. Employees can also see how well they fit prospective positions, gaps in skills, learning opportunities to gain skills, and connect with mentors.

Illustrative embodiments provide a method and system for employers to view potential candidates for open positions as well as identify potential talent for succession planning within an organization, identify skill gaps of such candidates and begin training them.

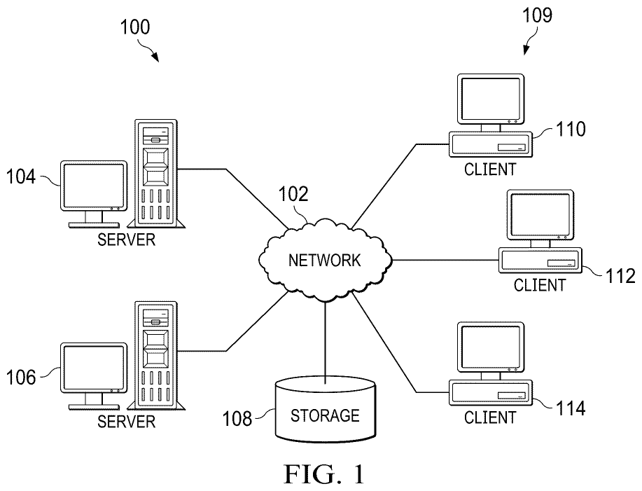

With reference now to the figures and, in particular, with reference to FIG. 1, an illustration of a diagram of a data processing environment is depicted in accordance with an illustrative embodiment. It should be appreciated that FIG. 1 is only provided as an illustration of one implementation and is not intended to imply any limitation with regard to the environments in which the different embodiments may be implemented. Many modifications to the depicted environments may be made.

The computer-readable program instructions may also be loaded onto a computer, a programmable data processing apparatus, or other device to cause a series of operational steps to be performed on the computer, a programmable apparatus, or other device to produce a computer implemented process, such that the instructions which execute on the computer, the programmable apparatus, or the other device implement the functions and/or acts specified in the flowchart and/or block diagram block or blocks.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is a medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers include client computer 110, client computer 112, and client computer 114. Client computer 110, client computer 112, and client computer 114 connect to network 102. These connections can be wireless or wired connections depending on the implementation. Client computer 110, client computer 112, and client computer 114 may be, for example, personal computers or network computers. In the depicted example, server computer 104 provides information, such as boot files, operating system images, and applications to client computer 110, client computer 112, and client computer 114. Client computer 110, client computer 112, and client computer 114 are clients to server computer 104 in this example. Network data processing system 100 may include additional server computers, client computers, and other devices not shown.

Program code located in network data processing system 100 may be stored on a computer-recordable storage medium and downloaded to a data processing system or other device for use. For example, the program code may be stored on a computer-recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

The illustration of network data processing system 100 is not meant to limit the manner in which other illustrative embodiments can be implemented. For example, other client computers may be used in addition to or in place of client computer 110, client computer 112, and client computer 114 as depicted in FIG. 1. For example, client computer 110, client computer 112, and client computer 114 may include a tablet computer, a laptop computer, a bus with a vehicle computer, and other suitable types of clients.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

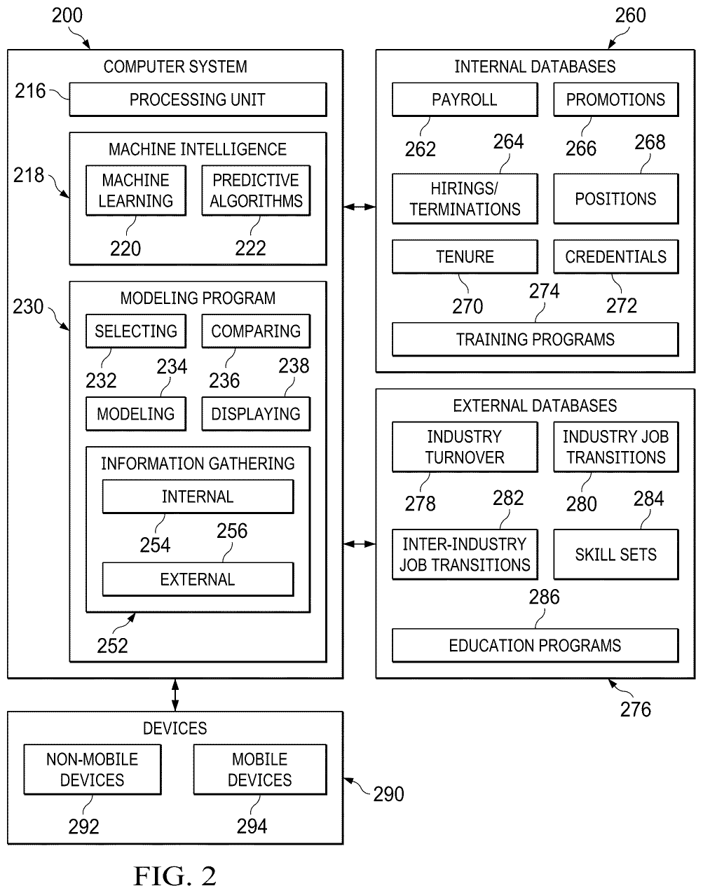

Turning to FIG. 2, a block diagram of a computer system for modeling is depicted in accordance with an illustrative embodiment. Computer system 200 is connected to internal databases 260, external databases 276, and devices 290. Internal databases 260 comprise payroll 262, hiring and terminations 264, promotions 266, job/positions within an organization 268, employee tenure records 270, credentials of employees 272, and training programs 274 offered by an organization.

External databases 276 comprise industry/sector employee turnover 278, industry/sector job transitions 280, job transitions between industries 282, skill sets 284 within industries and associated with specific jobs/positions, and education programs 286 that are relevant to skill sets 284.

Devices 290 comprise non-mobile devices 292 and mobile devices 294.

Computer system 200 comprises information processing unit 216, machine intelligence 218, and indexing program 230. Machine intelligence 218 comprises machine learning 220 and predictive algorithms 222.

Machine intelligence 218 can be implemented using one or more systems such as an artificial intelligence system, a neural network, a Bayesian network, an expert system, a fuzzy logic system, a genetic algorithm, or other suitable types of systems. Machine learning 220 and predictive algorithms 222 may make computer system 200 a special purpose computer for dynamic predictive modelling of employees and career paths.

In an embodiment, processing unit 216 comprises one or more conventional general purpose central processing units (CPUs). In an alternate embodiment, processing unit 216 comprises one or more graphical processing units (GPUS). Though originally designed to accelerate the creation of images with millions of pixels whose frames need to be continually recalculated to display output in less than a second, GPUs are particularly well suited to machine learning. Their specialized parallel processing architecture allows them to perform many more floating point operations per second then a CPU, on the order of 100× more. GPUs can be clustered together to run neural networks comprising hundreds of millions of connection nodes.

Modeling program 230 comprises information gathering 252, selecting 232, modeling 234, comparing 236, and displaying 238. Information gathering 252 comprises internal 254 and external 256. Internal 254 is configured to gather data from internal databases 260. External 256 is configured to gather data from external databases 276.

Thus, processing unit 216, machine intelligence 218, and modeling program 230 transform a computer system into a special purpose computer system as compared to currently available general computer systems that do not have a means to perform machine learning predictive modeling such as computer system 200 of FIG. 2. Currently used general computer systems do not have a means to accurately model employee career paths.

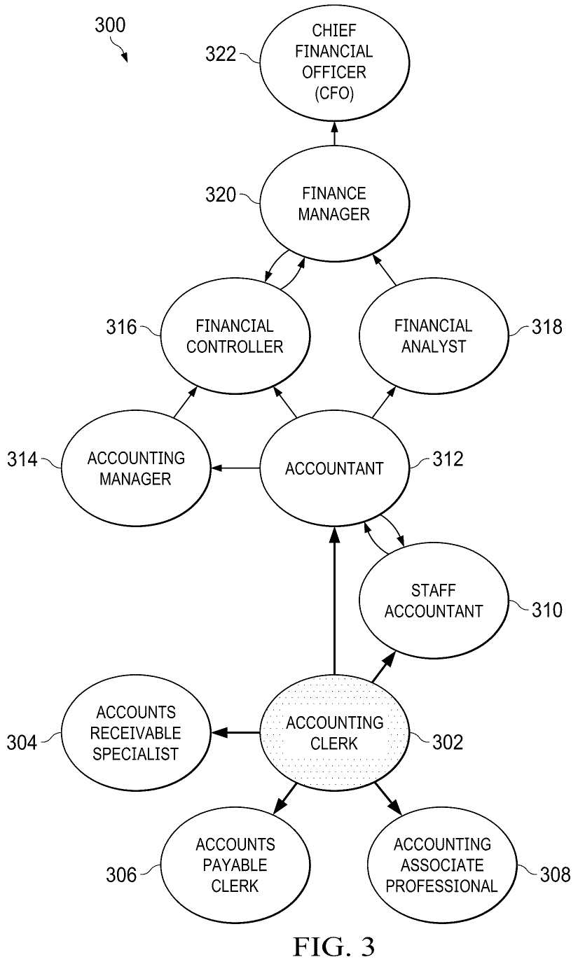

FIG. 3 is a career graph depicting potential paths between different employment positions in accordance with illustrative embodiments. In this particular example, career graph 300 relates to the general field of accounting/finance. However, career graphs can be applied to virtually any profession, industry, or sector, from health care to engineering to manufacturing, etc. It should also be noted that the jobs shown in career graph 300 can be either entirely within a single organization or distributed among multiple organizations.

In the example shown in FIG. 3, the job of accounting clerk 302 is taken as a starting point. From this starting point, career graph 300 illustrates other jobs that are likely to be direct transitions from accounting clerk 302. In this example, the likely transitions include accounts receivable specialist 304, accounts payable clerk 306, accounting associate professional 308, staff accountant 310, and accountant 212. These direct transitions are based on several factors such as similarity and overlap of skill sets and responsibilities, typical marginal progressions of skill sets and responsibilities, required credentials and experience, etc.

In some cases the transition between jobs can be either direct or indirect. In the example of career graph 300, the transition from accountant 312 to financial controller 316 can be direct or indirect through the position of accounting manager 314. In other cases, the transition to a specific job can occur through different paths. For example, in career graph 300, the transition from accountant 312 to finance manager 320 can occur via the position of financial controller 316 or financial analyst 318.

In addition, job transitions are not necessarily unidirectional. For example, as shown in career graph 300, an employee might transition from accountant 312 to staff accountant 310 or vice versa. Similarly, an employee might transition from financial controller 316 to finance manager 320 or vice versa.

Career graph 300 is a simple example of potential paths through different employment positions that is presented for ease of illustration. There is some degree of hierarchical relationship depicted among the jobs in career path 300, with chief financial officer 322 typically representing the highest financial position within an organization and accounting clerk 302 representing a typical entry level position. However, the transition between jobs in career graph 300 is not necessarily always a hierarchical transition, as illustrated by the example of financial controller 316 and finance manager 320 noted above.

Furthermore, job transitions do not necessarily have to be confined to a single firm, as mentioned above, nor do they have to be confined to a single profession or industry sector. For example, an employ could conceivably transition from finance to health care or manufacturing by way of management positions. Similarly, an engineer might transition into a management role that could in turn transition to employment in an industry unrelated to the technology involved in the engineer's original job.

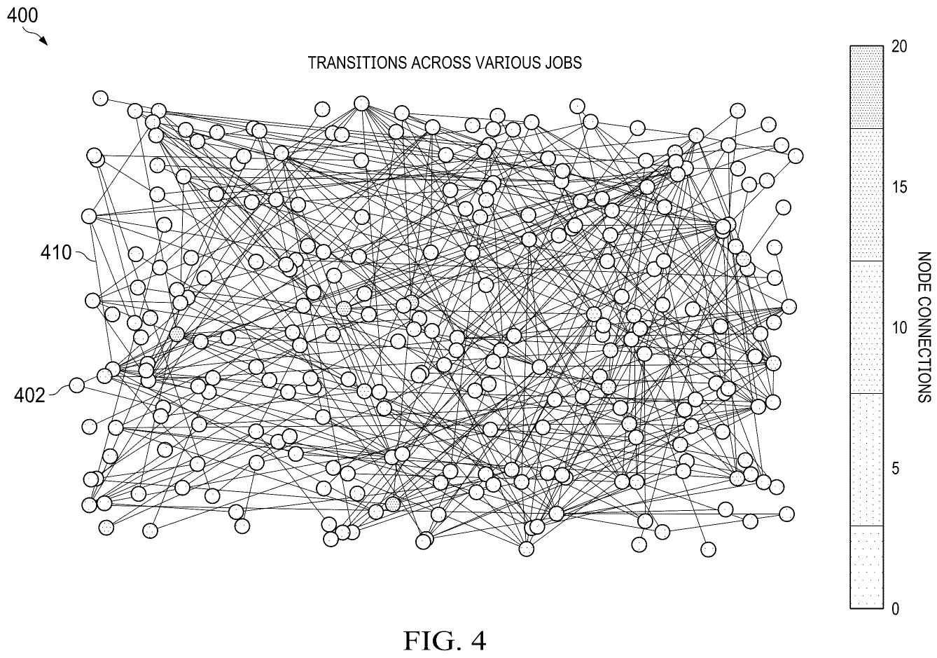

The accelerating division of labor within the modern economy, especially on an international scale, makes potential job transitions from any given starting point too complex for the human mind to comprehend, especially in light of the increasing number of potential job positions and the associated information associated with each one. FIG. 3 is a conceptual representation of a career path that illustrates how a current employment position can interrelate with other potential employment positions and possible transitions through those positions. A more comprehensive representation of the situation facing employees seeking to plan their careers is depicted in FIG. 4.

FIG. 4 depicts a graph of potential transitions across various jobs in accordance with illustrative embodiments. Job transition graph 400 illustrates the daunting complexity of potential job transitions within a modern economy. Each node 402 in graph 400 represents a job, which is connected to other jobs via edges 410. Some jobs have more node connections than others. However, an employee's career options are not limited to the number of jobs directly connected to a current position. For example, an employee might start in a job that has only five connections to other potential jobs and transition to another job that has ten connects to other jobs, which in turn are connected to more or less other potential positions. The practical consequence of such complexity is that most employees have only very limited knowledge of potential career paths and the necessary steps to pursue each one.

Humans do not have the cognitive capacity to comprehend potential career paths and opportunities much more complex than that shown in career graph 300 in FIG. 3. The illustrative embodiments provide the technical solution of employing advanced data processing and predictive modeling to navigate the complexity of potential career opportunities such as that shown in FIG. 4.

There are three main categories of machine learning: supervised, unsupervised, and reinforcement learning. Supervised machine learning comprises providing the machine with training data and the correct output value of the data. During supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

If unsupervised learning is used, not all of the variables and data patterns are labeled, forcing the machine to discover hidden patterns and create labels on its own through the use of unsupervised learning algorithms. Unsupervised learning has the advantage of discovering patterns in the data with no need for labeled datasets. Examples of algorithms used in unsupervised machine learning include k-means clustering, association analysis, and descending clustering.

Whereas supervised and unsupervised methods learn from a dataset, reinforcement learning methods learn from interactions with an environment. Algorithms such as Q-learning are used to train the predictive model through interacting with the environment using measurable performance criteria.

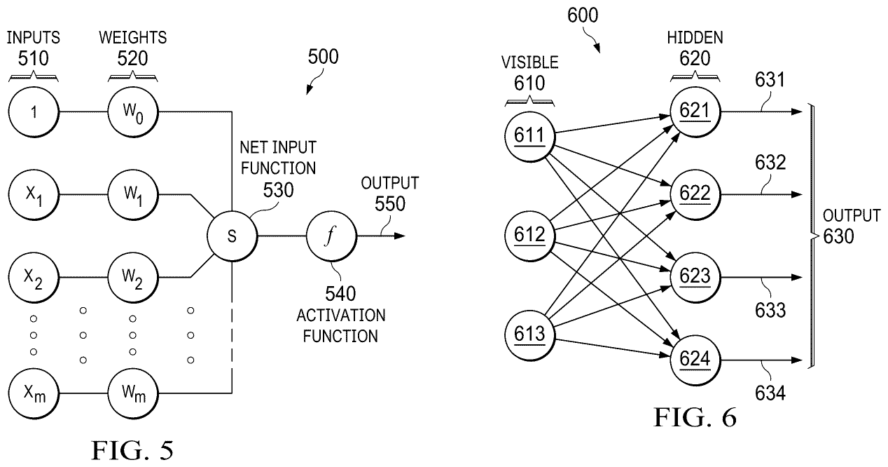

FIG. 5 is a diagram that illustrates a node in a neural network in which illustrative embodiments can be implemented. Node 500 combines multiple inputs 510 from other nodes. Each input 510 is multiplied by a respective weight 520 that either amplifies or dampens that input, thereby assigning significance to each input for the task the algorithm is trying to learn. The weighted inputs are collected by a net input function 530 and then passed through an activation function 540 to determine the output 550. The connections between nodes are called edges. The respective weights of nodes and edges might change as learning proceeds, increasing or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between. Each layer's output acts as the next layer's input.

Stochastic neural networks are a type of network that incorporate random variables, which makes them well suited for optimization problems. This is done by giving the nodes in the network stochastic (randomly determined) weights or transfer functions. A Boltzmann machine is a type of stochastic neural network in which each node is binary valued, and the chance of it firing depends on the other nodes in the network. Each node is a locus of computation that processes an input and begins by making stochastic decisions about whether to transmit that input or not. The weights (coefficients) that modify inputs are randomly initialized.

FIG. 6 is a diagram illustrating a restricted Boltzmann machine in which illustrative embodiments can be implemented. As shown in FIG. 6, the nodes in the Boltzmann machine 600 are divided into a layer of visible nodes 610 and a layer of hidden nodes 620. A common problem with general Boltzmann machines is that they stop learning correctly when they are scaled up. Restricted Boltzmann machines (RBMs) overcome this problem by using an architecture that does not allow connections between nodes in the same layer. As can be seen in FIG. 6, there is no intralayer communication between nodes.

The visible nodes 610 are those that receive information from the environment (i.e. a set of external training data). Each visible node in layer 610 takes a low-level feature from an item in the dataset and passes it to the hidden nodes in the next layer 620. When a node in the hidden layer 620 receives an input value x from a visible node in layer 610 it multiplies x by the weight assigned to that connection (edge) and adds it to a bias b. The result of these two operations is then fed into an activation function which produces the node's output.

In symmetric networks such as Boltzmann machine 600, each node in one layer is connected to every node in the next layer. For example, when node 621 receives input from all of the visible nodes 611-613 each x value from the separate nodes is multiplied by its respective weight, and all of the products are summed. The summed products are then added to the hidden layer bias, and the result is passed through the activation function to produce output 631. A similar process is repeated at hidden nodes 622-624 to produce respective outputs 632-634. In the case of a deeper neural network, the outputs 630 of hidden layer 620 serve as inputs to the next hidden layer.

Neural networks can be stacked to created deep networks. After training one neural net, the activities of its hidden nodes can be used as training data for a higher level, thereby allowing stacking of neural networks. Such stacking makes it possible to efficiently train several layers of hidden nodes. Examples of stacked networks include deep belief networks (DBN), deep Boltzmann machines (DBM), convolutional neural networks (CNN), recurrent neural networks (RNN), and spiking neural networks (SNN).

In bottom-up sequential learning, the weights are adjusted at each new hidden layer until that layer is able to approximate the input from the previous lower layer. Alternatively, undirected architecture allows the joint optimization of all levels, rather than sequentially up the layers of the stack.

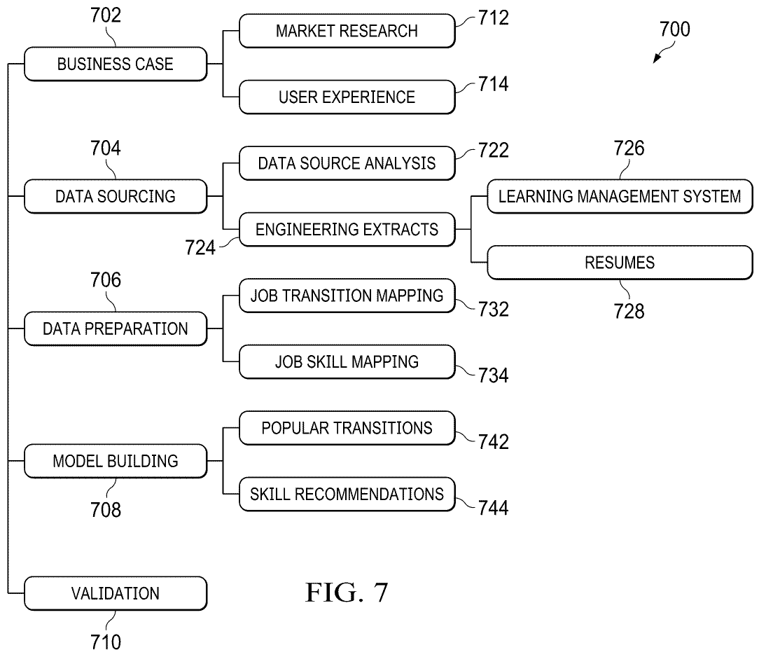

FIG. 7 depicts the process of building a career coaching system in accordance with illustrative embodiments. Process 700 begins with developing the business case for the system according to market research 712 of employment positions within various industries, sectors, and professions, as well as development of a user experience (UX) 714 for the system.

Data sourcing 704 includes data source analysis 722 of empirical data regarding factors such as job transitions, annual earnings, salary hikes, tenure in specific positions (turnover), etc. Data sourcing 704 also comprises engineering extracts 724 based on data collected from learning management system (LMS) 726 and resumes 728. LMS data covers information such as skill sets and competencies, training programs, and certifications required for certain positions. Resume data might comprise, among other things, previous positions held, certifications, and skill sets and competencies.

After the data is gathered, it undergoes preparation 706 before building the predictive model. Data preparation 706 comprises mapping job transitions 732 and mapping job skills 734.

After data preparation 706 is model building 708 using machine learning techniques such as those described above. The predictive model for career planning is based at least in part on popular job transitions 742 and recommended skills 744 for each position based on analysis of the empirical data. After building the model comes validation 710 using standard machine learning validation procedures.

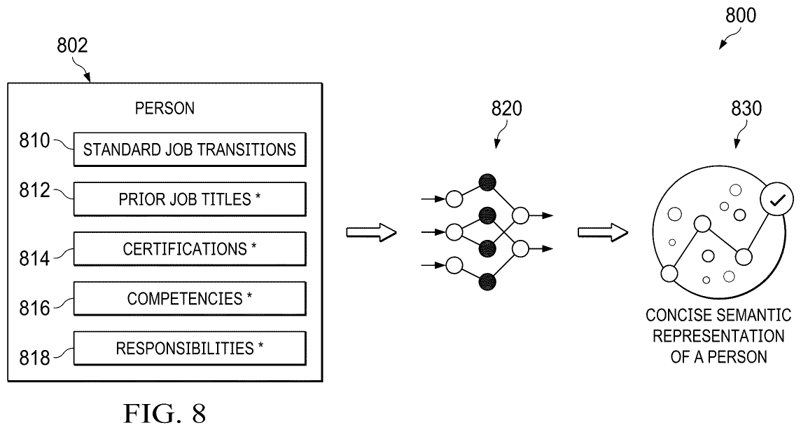

FIG. 8 depicts a process flow for model training in accordance with illustrative embodiments. One element of the illustrative embodiments is modeling individuals who have previously occupied specific employments positions (jobs). As more people who have held a given position are modeled, the predictive model for career planning is able to develop a more accurate representation of the type of person best suited for that particular job. Later users can then be compared to the model determine if they have the characteristics to be successful in that job.

Model training process 800 begins by collecting specific categories of information about a person 802. This information can include standard job transitions 810, prior job titles/positions held 812, certifications 814, skill sets and competencies 816, and past responsibilities 818.

The information about person 802 is then fed into a neural network 820, which produces a concise semantic representation 830 of the person.

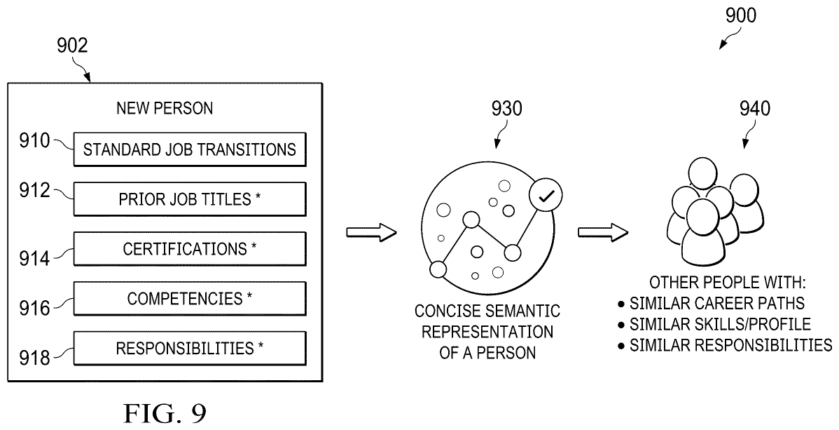

FIG. 9 depicts a process flow for model development in accordance with illustrative embodiments. Model development process 900 comprises the situation in which data on a new person 902 is gathered after the model has already been trained.

Similar to process 800, process 900 begins by gathering user information regarding standard job transitions 810, prior job titles/positions held 812, certifications 814, skill sets and competencies 816, and past responsibilities 818 for the new person 902. This user information can be gathered from a resume submitted by the new person 902 or alternatively might be entered directly into the career coaching system by the user.

From this information, process 900 produces a concise semantic representation 930 of the new person 902 using the model trained in process 800. This semantic representation 930 can then be compared to other persons 940 already modeled in the system. This comparison can be based on similarities in career path, skill sets, and responsibilities.

As more new users use the system, the model can be updated and refined by the new user information.

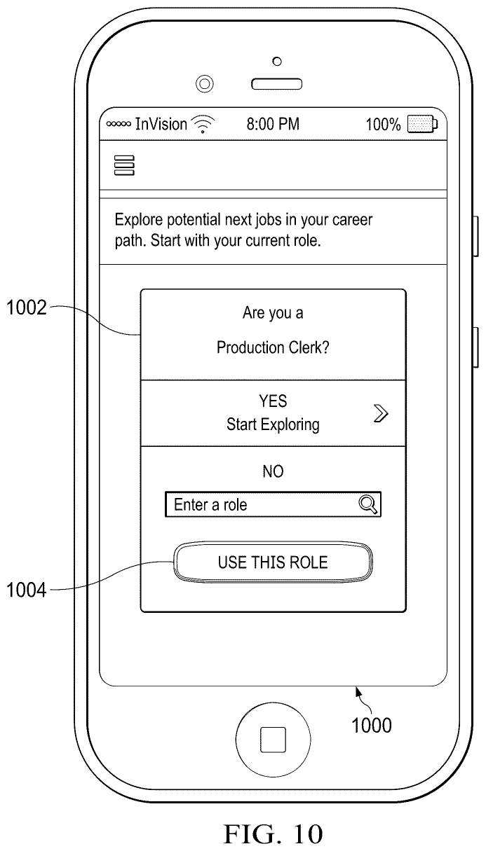

FIG. 10 depicts a user interface start screen for a career coaching system in accordance with illustrative embodiments. Start screen 1000 provides an initial default job position 1002 for selection. In the present example, the starting position is production clerk. Alternatively, screen 1000 also provides an entry field 1004 for a user to enter a different initial job position.

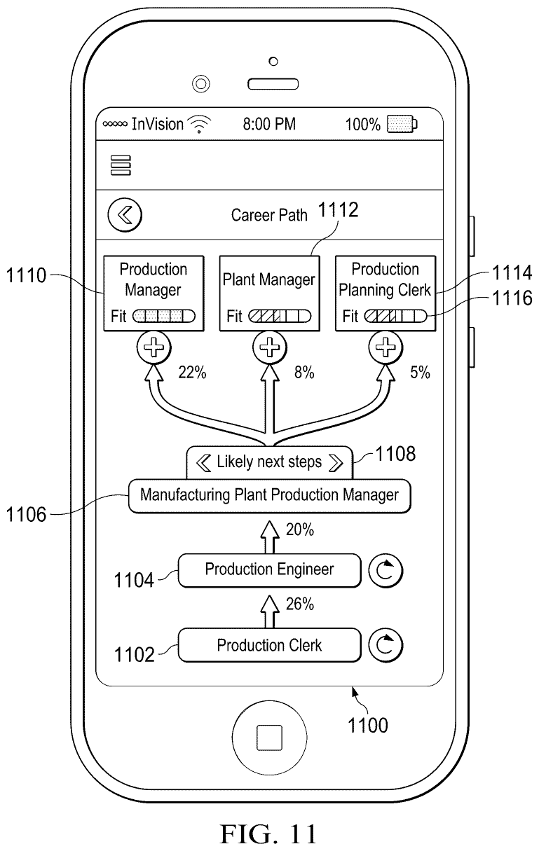

FIG. 11 depicts a user interface career path display for a career coaching system in accordance with illustrative embodiments. Career path screen 1100 displays a likely career path based on the initial job of production clerk 1102. In this example, based on the predictive model of similar persons who have previously occupied these positions and their similarity to the user, the system predicts that there is a 26% likelihood that the next job transition for the user would be to production engineer 1104. From production engineer 1104 there is a 20% likelihood that the next job transition is to manufacturing plant production manager 1106.

At this point the career path displays a branching 1108 of three likely next steps. In the present example, there is a 22% likelihood of transitioning to the role of productions manager 1110. There is an 8% likelihood of transitioning to plant manager 1112. There is a 5% likelihood of transitioning to production planning clerk 1114. Each of positions 1110, 1112, and 1114 displays a respective Fit 1116 between the user and the job in question based on the user's information and how closely it matches that of past occupants of the jobs.

The user can select any of the employment positions shown on career path screen 1100 to obtain more information about what is entailed with the job.

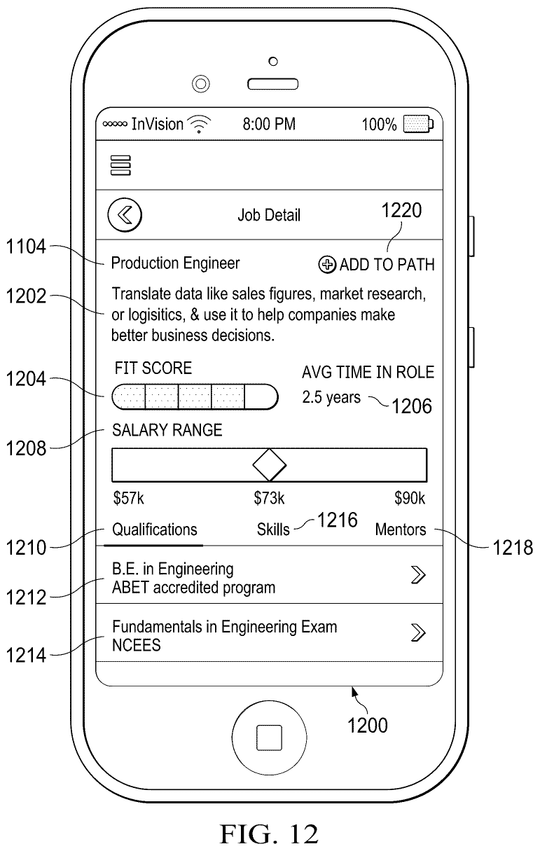

FIG. 12 depicts a user interface job detail display for a career coaching system in accordance with illustrative embodiments. In this particular example, the user has selected Production Engineer 1104 from screen 1100. Job detail screen 1200 provides a concise description 1202 of the functions typically performed by a production engineer. Also provided is a fit score 1204 of the user in question for this type of job. Job details also include the average time 1206 that past employees have spent in this role as well as the salary range typical for this type of job.

The job detail screen 1200 provides descriptions of official qualifications/credentials 1210 typically required for the job, skill sets 1216 required, and a list of potential mentors 1218 for the user. In the present example, the user has selected qualifications 1210 for additional detail. According to the system in this example, the position of Production Engineer typically requires a bachelors degree in engineering 1212 and passing the NCEES Fundamentals in Engineering Exam 1214.

Skills 1216 might contain more specific description of the skill sets and competencies typically possessed by most occupants of the job. Official qualifications such as degrees and professional licensing exams are usually used as indirect proxies for the skills required on the job. However, such credentials might be similar across many job positions and do not provide enough details regarding the day to day skills used by production engineer or any type of job.

The list of potential mentors 1218 is selected from people who have occupied the job position in the past. The selection can be based on objective data regarding past performance. Examples of such data include hiring offers for the position, tenure, promotions, salaries, raises and bonuses, and other objective indicia of success in the job.

If the user is interested in the job based on the supplied information, screen 1200 provides a selection option 1220 to add the job to the user's planned career path.

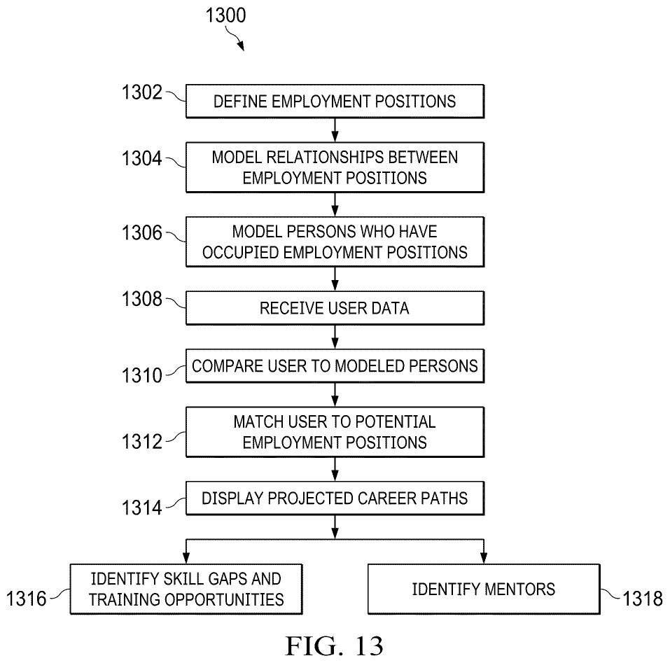

FIG. 13 depicts a process flow for determining a projected career path in accordance with illustrative embodiments. Process 1300 operates from the perspective of a user desiring to plan a career path. Process 1300 begins by defining a number of employment positions (jobs) including require skill sets and competencies required to perform the job (step 1302) and models relations between the employment positions based on factors such as require skill sets and responsibilities (step 1304).

Process 1300 models persons who have previously occupied the employment positions according to skills, employment history, and job performance (step 1306). The modeling produces a representation of the type of person that typically occupies a given job. Factors that can contribute to modeling persons and their performance in a job include, e.g., standard job transitions, hirings (job offers and acceptances), prior job titles, promotions, salary and compensation (including raises and bonuses), certifications, credentials, and responsibilities.

User data comprising skills, employment history (including current job), and job performance are received from a user seeking to determine a career path (step 1308). This user data is then compared to the modeled persons (step 1310).

Based on the similarity of the user to the modeled persons, process 1300 matches the user to a number of potential employment positions (step 1312). These potential employment positions are then displayed to the user as a projected career path such as that shown in FIG. 11 (step 1314).

Process 1300 might also identify skill gaps in the user's information and display training and educational opportunities to fill those gaps in order to proceed through the projected career path (step 1316). Process 1300 might also display a list of mentors who have successfully occupied the jobs in the past and perhaps followed similar career paths themselves (step 1318).

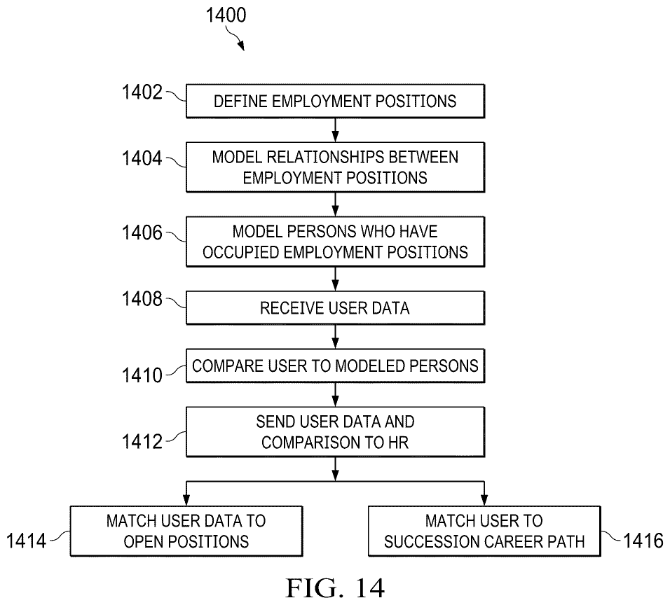

FIG. 14 depicts a process flow for identifying potential employees in accordance with illustrative embodiments. Process 1400 operates from the perspective of human resources (HR) personnel who are looking to fill open positions or identify candidates for succession to leadership positions with an organization.

Initial steps of process 1400 are similar to those of process 1300. Process 1400 begins by defining a number of employment positions (step 1402) and modeling relations between them (step 1404). Past occupants of each job are modeled based on skills, employment history, and job performance (step 1406). When user data is received from a user (step 1408), it is compared to the modeled persons (step 1410).

Based on the results of the comparison to the models, the user data is then forwarded to HR personnel in a number of organizations (step 1412). Depending on the needs and priorities of the respective HR personnel, the user data is matched to open positions within their organizations they are looking to fill (step 1414).

Alternatively, the user data might be matched to succession career paths within an organization (step 1416). Just as employees seek to plan their long-term careers, organizations must also think in terms of long-term succession for senior positions. Many leadership positions require extensive training and experience which is often specific to a given organization. A succession career path comprises a number of employment positions within an organization leading the user to succeed a current occupant of a designated position within the organization such, e.g., as Chief Financial Officer or Chief Executive Office.

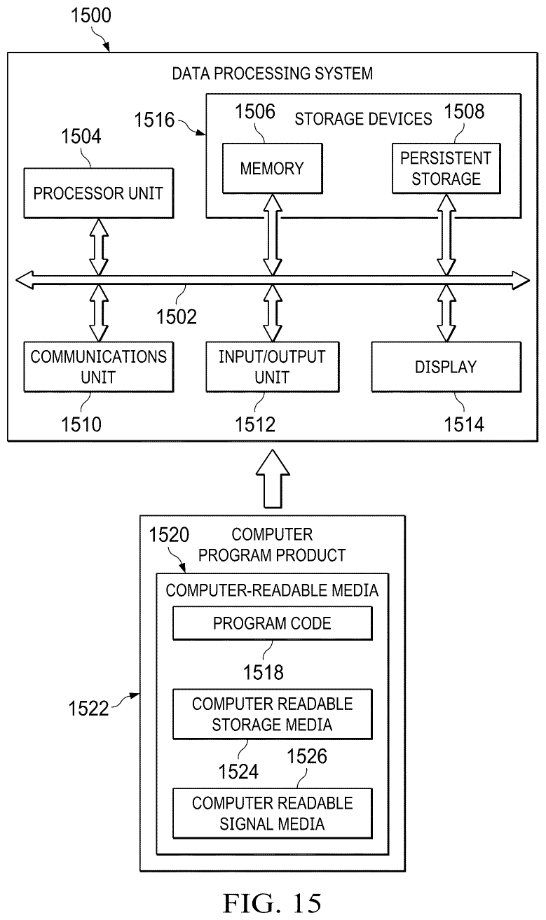

Turning now to FIG. 15, an illustration of a block diagram of a data processing system is depicted in accordance with an illustrative embodiment. Data processing system 1500 may be used to implement one or more computers and client computer system 112 in FIG. 1. In this illustrative example, data processing system 1500 includes communications framework 1502, which provides communications between processor unit 1504, memory 1506, persistent storage 1508, communications unit 1510, input/output unit 1512, and display 1514. In this example, communications framework 1502 may take the form of a bus system.

Processor unit 1504 serves to execute instructions for software that may be loaded into memory 1506. Processor unit 1504 may be a number of processors, a multi-processor core, or some other type of processor, depending on the particular implementation. In an embodiment, processor unit 1504 comprises one or more conventional general purpose central processing units (CPUs). In an alternate embodiment, processor unit 1504 comprises one or more graphical processing units (GPUS).

Memory 1506 and persistent storage 1508 are examples of storage devices 1516. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1516 may also be referred to as computer-readable storage devices in these illustrative examples. Memory 1516, in these examples, may be, for example, a random access memory or any other suitable volatile or non-volatile storage device. Persistent storage 1508 may take various forms, depending on the particular implementation.

For example, persistent storage 1508 may contain one or more components or devices. For example, persistent storage 1508 may be a hard drive, a flash memory, a rewritable optical disk, a rewritable magnetic tape, or some combination of the above. The media used by persistent storage 1508 also may be removable. For example, a removable hard drive may be used for persistent storage 1508. Communications unit 1510, in these illustrative examples, provides for communications with other data processing systems or devices. In these illustrative examples, communications unit 1510 is a network interface card.

Input/output unit 1512 allows for input and output of data with other devices that may be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs may be located in storage devices 1516, which are in communication with processor unit 1504 through communications framework 1502. The processes of the different embodiments may be performed by processor unit 1504 using computer-implemented instructions, which may be located in a memory, such as memory 1506.

These instructions are referred to as program code, computer-usable program code, or computer-readable program code that may be read and executed by a processor in processor unit 1504. The program code in the different embodiments may be embodied on different physical or computer-readable storage media, such as memory 1506 or persistent storage 1508.

Program code 1518 is located in a functional form on computer-readable media 1520 that is selectively removable and may be loaded onto or transferred to data processing system 1500 for execution by processor unit 1504. Program code 1518 and computer-readable media 1520 form computer program product 1522 in these illustrative examples. In one example, computer-readable media 1520 may be computer-readable storage media 1524 or computer-readable signal media 1526.

In these illustrative examples, computer-readable storage media 1524 is a physical or tangible storage device used to store program code 1518 rather than a medium that propagates or transmits program code 1518. Alternatively, program code 1518 may be transferred to data processing system 1500 using computer-readable signal media 1526.

Computer-readable signal media 1526 may be, for example, a propagated data signal containing program code 1518. For example, computer-readable signal media 1526 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1500 are not meant to provide architectural limitations to the manner in which different embodiments may be implemented. The different illustrative embodiments may be implemented in a data processing system including components in addition to or in place of those illustrated for data processing system 1500. Other components shown in FIG. 15 can be varied from the illustrative examples shown. The different embodiments may be implemented using any hardware device or system capable of running program code 1518.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1.-24. (canceled)

25. A system, comprising:
one or more processors, coupled with memory, that execute a machine learning-based modeling program to:
receive first profile data associated with a first profile of a plurality of profiles, each profile associated with an electronic account, wherein the first profile data comprises a plurality of data categories including transitions, prior positions, certifications, skills, and past responsibilities;
provide the first profile data to a neural network, wherein the neural network comprises a plurality of visible nodes and hidden nodes configured to evaluate data to generate a data graph comprising a plurality of task nodes representing a plurality of tasks and a plurality of edges connecting the plurality of task nodes;
generate, using the neural network, a representation of the first profile corresponding to the first profile data;
receive second profile data associated with a second profile of the plurality of profiles, wherein the second profile data comprises the plurality of data categories;
generate, using the neural network, a representation of the second profile corresponding to the second profile data;
compare the representation of the first profile with the representation of the second profile to determine similarities between the transitions, prior positions, certifications, skills, and past responsibilities of the first profile and the second profile;
update the neural network based on the comparison of the first profile and the second profile to improve performance of the neural network in generation of subsequent outputs from the neural network; and
display a graphical user interface with content generated based on the subsequent outputs from the neural network that is updated based on the comparison of the first profile and the second profile.

26. The system of claim 25, wherein the one or more processors are further configured to:
cause the plurality of visible nodes and hidden nodes to multiply one or more inputs from the first profile data or the second profile data with one or more weights to create one or more weighted inputs.

27. The system of claim 26, wherein the one or more weights increase or decrease the significance of an input, and the one or more weights are configured to change responsive to an update to the neural network.

28. The system of claim 27, wherein the one or more weighted inputs are passed through at least one of a net input function or an activation function to create an output.

29. The system of claim 25, wherein the neural network is at least one of a restricted Boltzmann machine, a deep Boltzmann machine, a deep belief network, a convolutional neural network, a spiking neural network, or a recurrent neural network.

30. The system of claim 25, wherein the one or more processors are further configured to:
define a number of positions, wherein each position comprises a number of required skills;
generate, using the neural network, a model of relationships between the positions, wherein the model maps potential transitions between positions according to similarities of required skills;
generate, using the neural network, a model of a number of persons who have occupied the positions according to skills, employment history, and job performance;
receive user data from a user device, wherein the user data comprises skills, employment history, and job performance;
compare the user data to the model of the number of persons;
match a number of potential employment opportunities from among the number of positions to the user data based on similarities between the user data and the number of persons;
identify gaps in the skills of the user data in relation to required skills of the number of potential employment opportunities;
identify a number of training opportunities to fill the gaps in the skills of the user data; and
display in the graphical user interface a potential career path of the user data.

31. The system of claim 30, wherein the potential career path comprises a number of job transitions between different jobs starting from an initial job, wherein each transition is displayed with a predicted likelihood of a transition, an indication of the transition directly to multiple alternate jobs or branching parallel transitions to the alternate jobs, and wherein each of the alternate jobs is displayed with a respective fit between the user and the job based on a match between information about the user and prior occupants of the job.

32. A method, comprising:
receiving, by one or more processors coupled with memory, first profile data associated with a first profile of a plurality of profiles, each profile associated with an electronic account, wherein the first profile data comprises a plurality of data categories including transitions, prior positions, certifications, skills, and past responsibilities;
providing, by the one or more processors, the first profile data to a neural network, wherein the neural network comprises a plurality of visible nodes and hidden nodes configured to evaluate data to generate a data graph comprising a plurality of task nodes representing a plurality of tasks and a plurality of edges connecting the plurality of task nodes;
generating, by the one or more processors using the neural network, a representation of the first profile corresponding to the first profile data;
receiving, by the one or more processors, second profile data associated with a second profile of the plurality of profiles, wherein the second profile data comprises the plurality of data categories;
generating, by the one or more processors using the neural network, a representation of the second profile corresponding to the second profile data;
comparing, by the one or more processors, the representation of the first profile with the representation of the second profile to determine similarities between the transitions, prior positions, certifications, skills, and past responsibilities of the first profile and the second profile; and
updating, by the one or more processors, the neural network based on the comparison of the first profile and the second profile to improve performance of the neural network in generation of subsequent outputs from the neural network.

33. The method of claim 32, comprising:
causing, by the one or more processors, the plurality of visible nodes and hidden nodes to multiply one or more inputs from the first profile data or the second profile data with one or more weights to create one or more weighted inputs.

34. The method of claim 33, wherein the one or more weights increase or decrease the significance of the input and wherein the one or more weights are dynamic and change as the neural network is updated.

35. The method of claim 33, wherein the one or more weighted inputs are passed through at least one of a net input function or an activation function to create an output.

36. The method of claim 32, wherein the neural network is at least one of a restricted Boltzmann machine, a deep Boltzmann machine, a deep belief network, a convolutional neural network, a spiking neural network, or a recurrent neural network.

37. The method of claim 32, further comprising:
defining, by the one or more processors coupled with memory, a number of positions, wherein each position comprises a number of required skills;
modelling, by the one or more processors coupled with memory and using the neural network, relationships between the positions, wherein the model maps potential transitions between positions according to similarities of required skills;
modelling, by the one or more processors coupled with memory and using the neural network, a number of persons who have occupied the positions according to skills, employment history, and job performance;
receiving, by the one or more processors coupled with memory, user data from a user device, wherein the user data comprises skills, employment history, and job performance;
comparing, by the one or more processors coupled with memory, the user data to the number of persons;
matching, by the one or more processors coupled with memory, a number of potential employment opportunities from among the number of positions to the user data based on similarities between the user data and the number of persons;
identifying, by the one or more processors coupled with memory, gaps in the skills of the user data in relation to required skills of the number of potential employment opportunities;
identifying, by the one or more processors coupled with memory, a number of training opportunities to fill the gaps in the skills of the user data; and
displaying, by the one or more processors coupled with memory, in a graphical user interface a potential career path of the user data.

38. The method of claim 37, wherein the potential career path comprises a number of job transitions between different jobs starting from an initial job, wherein each transition is displayed with a predicted likelihood of a transition, an indication of the transition directly to multiple alternate jobs or branching parallel transitions to the alternate jobs, and wherein each of the alternate jobs is displayed with a respective fit between the user and the job based on a match between information about the user and prior occupants of the job.

39. A non-transitory computer-readable medium storing processor executable instructions, that upon execution by one or more processors, cause the one or more processors to:
receive first profile data associated with a first profile of a plurality of profiles, each profile associated with an electronic account, wherein the first profile data comprises a plurality of data categories including transitions, prior positions, certifications, skills, and past responsibilities;
provide the first profile data to a neural network, wherein the neural network comprises a plurality of visible nodes and hidden nodes configured to evaluate data to generate a data graph comprising a plurality of task nodes representing a plurality of tasks and a plurality of edges connecting the plurality of task nodes;
generate, using the neural network, a representation of the first profile corresponding to the first profile data;
receive second profile data associated with a second profile of the plurality of profiles, wherein the second profile data comprises the plurality of data categories;
generate, using the neural network, a representation of the second profile corresponding to the second profile data;
compare the representation of the first profile with the representation of the second profile to determine similarities between the transitions, prior positions, certifications, skills, and past responsibilities of the first profile and the second profile; and
update the neural network based on the comparison of the first profile and the second profile to improve performance of the neural network in generation of subsequent outputs from the neural network.

40. The non-transitory computer-readable medium of claim 39, wherein the instructions further include instructions to cause the plurality of visible nodes and hidden nodes to multiply one or more inputs from the first profile data or the second profile data with one or more weights to create one or more weighted inputs.

41. The non-transitory computer-readable medium of claim 40, wherein the one or more weights increase or decrease the significance of an input, and the one or more weights are configured to change responsive to an update to the neural network.

42. The non-transitory computer-readable medium of claim 41, wherein the one or more weighted inputs are passed through at least one of a net input function or an activation function to create an output.

43. The non-transitory computer-readable medium of claim 39, wherein the neural network is at least one of a restricted Boltzmann machine, a deep Boltzmann machine, a deep belief network, a convolutional neural network, a spiking neural network, or a recurrent neural network.

44. The non-transitory computer-readable medium of claim 39, wherein the one or more processors are further configured to:
define a number of positions, wherein each position comprises a number of required skills;
generate, using the neural network, a model of relationships between the positions, wherein the model maps potential transitions between positions according to similarities of required skills;
generate, using the neural network, a model of a number of persons who have occupied the positions according to skills, employment history, and job performance;
receive user data from a user device, wherein the user data comprises skills, employment history, and job performance;
compare the user data to the number of persons;
match a number of potential employment opportunities from among the number of positions to the user data based on similarities between the user data and the number of persons;
identify gaps in the skills of the user data in relation to required skills of the number of potential employment opportunities;
identify a number of training opportunities to fill the gaps in the skills of the user data; and
display in a graphical user interface a potential career path of the user data.
